(19) United States
(12) Patent Application Publication
(10) Pub. No.: US 2021/0048063 A1
(43) Pub. Date: Feb. 18, 2021

(54) BEARING SUPPORT STRUCTURE

(71) Applicant: JTEKT CORPORATION, Osaka-shi, Osaka (JP)

(72) Inventors: Kunihiro YAMAGUCHI, Nagoya-shi (JP); Kensuke KIMURA, Yokohama-shi (JP)

(73) Assignee: JTEKT CORPORATION, Osaka-shi, Osaka (JP)

(21) Appl. No.: 16/978,098

(22) PCT Filed: Jan. 25, 2019
(86) PCT No.: PCT/JP2019/002433

§ 371 Date: Sep. 3, 2020

(30) Foreign Application Priority Data
Mar. 20, 2018 (JP) 2018-053364

(51) Int. Cl. F16C 19/26; F16C 3/06; F16C 33/60; F16C 35/063; F16C 9/02

(52) U.S. Cl. CPC F16C 19/26; F16C 3/06; F16C 9/02; F16C 35/063; F16C 33/60

(57) ABSTRACT

A bearing support structure in which a split rolling bearing split into two in a peripheral direction is mounted on the outer periphery of a rotatable shaft member, the shaft member includes a cylindrical shaft portion, and a first side surface and a second side surface that face each other in an axial direction with the shaft portion sandwiched therebetween and that extend in a substantially radial direction, and at least one of the first side surface and the second side surface is inclined with respect to a plane orthogonal to a central axis of the shaft member.

### TECHNICAL FIELD

One aspect of the present invention relates to a support structure of a rotary shaft by a split rolling bearing in which an inner ring is split in a peripheral direction.

### BACKGROUND ART

In a crankshaft of an internal combustion engine used for vehicles such as automobiles or outboard motors, a journal portion has conventionally been rotatably supported by a slide bearing. However, since the sliding bearing needs to supply a large amount of lubricating oil and requires a dedicated oiling device, the weight of the vehicle increases. Therefore, in recent years, efforts have been made to reduce the weight of a vehicle by eliminating the need for the oiling device by changing the sliding bearing to a rolling bearing.

Since journal portions of the crankshaft is in a position sandwiched in the axial direction by the crank arms, the annular rolling bearing cannot be mounted as it is. For this reason, a split rolling bearing split in two portions into two in the peripheral direction is used (see Patent Literatures 1 to 2).

Split semicircular rolling bearings are mounted on both sides in the radial direction with the journal portion interposed therebetween. The semicircular rolling bearing is integrally assembled and fixed to an inner periphery of a housing. A hardened layer is formed on the outer periphery of the journal portion by induction hardening, then a grinding process is performed, and an inner raceway surface of the split rolling bearing is formed. In this way, the crankshaft can freely rotate about the journal portions.

### PRIOR ART LITERATURE

### Patent Literature

[Patent Literature 1] JP-A-2007-139153
[Patent Literature 2] JP-A-2012-225426

### SUMMARY OF INVENTION

### Technical Problem

In the split rolling bearing of Patent Literatures 1 and 2, a rolling element rolls directly on the outer peripheral surface of the journal portion. In order to use the journal portion as the raceway surface of the rolling bearing, it is necessary to set the hardness of the surface to approximately 60 HRC or more. However, since the crankshaft manufactured by hot forging has a relatively low carbon content of about 0.3% to 0.5%, it is difficult to increase the surface hardness.

Therefore, it is desired to ensure the life of the rolling bearing by mounting an inner ring having a sufficient hardness, which is separate from the crankshaft, on the outer periphery of the journal portion. At this time, the inner ring is split into two in the peripheral direction similarly to the outer ring, and is mounted on both sides in the radial direction with the journal portion interposed therebetween.

However, even in a case where the split inner ring is set such that the bore diameter when assembled is set to be smaller than the outside diameter of the journal portion, a clearance is only formed on split planes that faces each other in the peripheral direction, and it is not possible to fit the outer periphery of the journal portion with a tight margin. Therefore, when the crankshaft rotates, the inner ring may rotate in the peripheral direction. When the split plane of the inner ring moves to the load area of the rolling bearing, abnormal noise may occur when the rolling element passes through the portion where the clearance is formed.

As shown in FIG. 5, as a means for preventing the inner ring 51 from rotating about the journal portion 52, a method of incorporating a pin 53 that radially passing through the inner ring 51 and the journal portion 52 or incorporating a key (not shown) on a fitting surface between the inner ring 51 and the journal portion 52 may be considered. However, when the pin 53 is incorporated, the hole 54 through which the pin 53 is inserted opens on the outer periphery of the inner ring 51. In the internal combustion engine, since there is a strong demand for weight reduction and the radial thickness of the inner ring 51 is small, the pin 53 and the key may protrude to the outer periphery of the inner ring 51. Therefore, the rolling element 55 needs to roll away from the hole 54 or the key through which the pin 53 or the pin 53 is inserted, and the axial length of the inner raceway surface where the rolling element 55 and the inner ring 51 contact each other is shortened. As a result, there is a problem that the load capacity of the rolling bearing is reduced and the rolling life is shortened.

Therefore, an aspect of the present invention is to prevent rotation of an inner ring and occurrence of abnormal noise while ensuring a rolling life even when a split rolling bearing in which an inner ring is split in a peripheral direction is used.

### Solution to Problem

In one aspect of the present invention, in a bearing support structure in which a split rolling bearing split in two portions in a peripheral direction is mounted on an outer periphery of a rotatable shaft member, the shaft member includes a cylindrical shaft portion, and a first side surface and a second side surface facing each other in an axial direction with the shaft portion sandwiched therebetween and extending in a substantially radial direction. At least one of the first side surface and the second side surface is inclined with respect to a plane orthogonal to a central axis of the shaft member. The split rolling bearing includes an inner ring having a substantially cylindrical shape, an inner raceway surface formed on an outer periphery, and a first end surface and a second end surface that extend substantially in the radial direction at both axial ends, and split into two in the peripheral direction, an outer ring disposed radially outward of the inner ring, having an outer raceway surface formed on the inner periphery, and split into two in a peripheral direction, and a plurality of rolling elements disposed between the inner raceway surface and the outer raceway surface. The inner ring is incorporated in an outer periphery of the shaft portion such that the first end surface and the first side surface face each other in the axial direction and the second end surface and the second side surface face each other in the axial direction. Rotation of the inner ring with respect to the shaft portion is prevented, by forming the first end surface in the same direction as the first side surface, and forming the second end surface in the same direction as the second side surface.

### Advantageous Effects of Invention

According to the aspect of the present invention, even when the split rolling bearing in which the inner ring is split in the peripheral direction is used, it is possible to prevent the rotation of the inner ring and the occurrence of the abnormal noise while ensuring the rolling life.

### BRIEF DESCRIPTION OF DRAWINGS

FIG. 1 is an axial sectional view illustrating a configuration of a crankshaft into which a split rolling bearing of a first embodiment is incorporated.

FIG. 2 is an enlarged axial sectional view of a crank journal portion.

FIG. 3(a) is an axial sectional view of a split rolling bearing, and FIG. 3(b) is a front view when viewed from the axial direction.

FIG. 4 is a sectional view in a direction orthogonal to a rotation axis of the journal portion indicated by an arrow J in FIG. 1.

FIG. 5 is a sectional view showing an example of a conventional rotation stopper.

### DESCRIPTION OF EMBODIMENTS

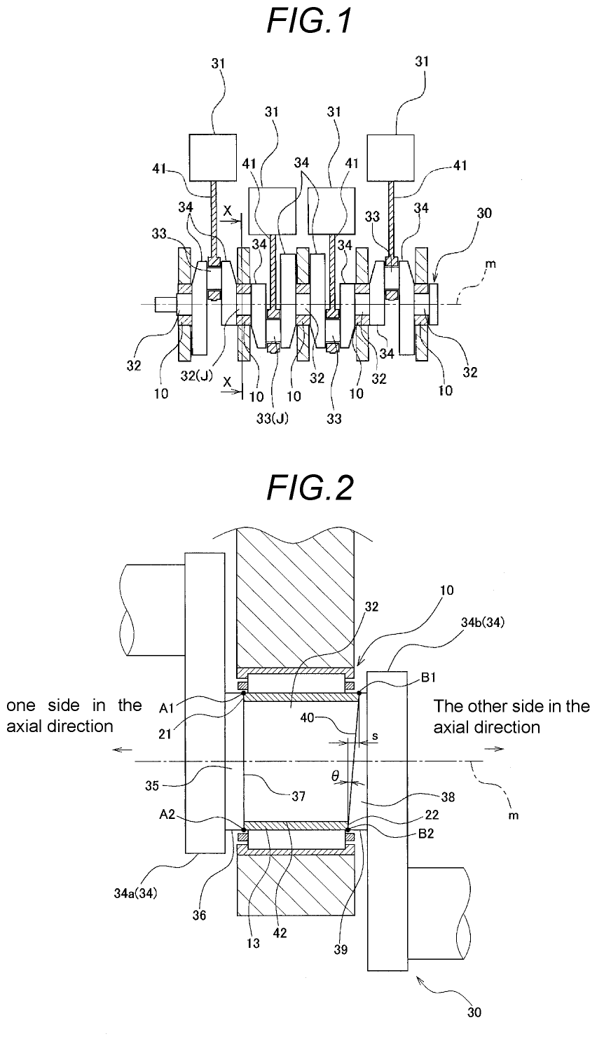

An embodiment of a split rolling bearing according to the present invention will be described in detail with reference to the drawings. FIG. 1 is an axial sectional view showing a structure of a crankshaft 30 (shaft member) in which a split rolling bearing 10 according to a first embodiment of the present invention is incorporated. The crankshaft 30 is a component that is incorporated in an internal combustion engine such as an outboard motor or an automobile and converts reciprocating motion of pistons 31 into rotational motion. In the following description, a direction of a central axis m of the crankshaft 30 is referred to as an axial direction, a direction orthogonal to the axial direction is referred to as a radial direction, and a direction about the central axis m is referred to as a peripheral direction.

The crankshaft 30 is manufactured by hot forging a carbon steel or alloy steel having a carbon content of about 0.3% to 0.5%, and is integrally formed with a plurality of journal portions 32 (shaft portions), a plurality of pin portions 33, and a plurality of crank arms 34 connecting the journal portions 32 and the pin portions 33. In the crankshaft 30 of FIG. 1, journal portions 32 are formed at five positions in the axial direction, and pin portions 33 are formed at four positions in the axial direction.

After forging, journal portions 32 are finished into cylindrical shapes coaxial with each other by performing a turning process and a grinding process on the outer periphery of each journal portion after forging. A split rolling bearing 10 is incorporated in the outer periphery of each journal portion 32, and the crankshaft 30 can rotate about the journal portion 32.

Each pin portion 33 is provided parallel to the central axis m at a position eccentric in the radial direction from the journal portion 32, and is finished into a cylindrical shape by performing a turning process and a grinding process on each outer periphery after forging.

Each pin portion 33 is connected to the piston 31 via a connecting rod 41. In the internal combustion engine, by periodically explosively combusting fuel such as gasoline, the pistons 31 are displaced, the pin portions 33 are biased in the peripheral direction, and the crankshaft 30 rotates. At this time, since a large load repeatedly acts on the pin portion 33 and the journal portion 32, induction hardening is performed on the outer peripheral surface of each of the pin portion and the journal portion, and the fatigue strength is ensured.

Next, the configuration of the journal portion 32 will be described in detail. Since the configuration of each journal portion 32 of the crankshaft 30 is the same, the journal portion 32 denoted by the reference sign J will be described as an example in FIG. 1. FIG. 2 is an axial sectional view of the journal portion 32 in which the split rolling bearing 10 is incorporated. For convenience of description, the left side of FIG. 2 is referred to as the “one side in the axial direction”, and the right side of FIG. 2 is referred to as “the other side in the axial direction”. In FIG. 2, the crank arm 34 on the left side of the journal portion 32 is referred to as a “first crank arm 34a”, and the right crank arm 34 is referred to as a “second crank arm 34b”.

A first flange portion 35 protruding in the axial direction toward the journal portion 32 is formed on a side surface of the first crank arm 34a on the other side in the axial direction. The outer peripheral surface 36 of the first flange portion 35 is a cylindrical surface coaxial with the journal portion 32, and the outside diameter thereof is larger than the outside diameter of the journal portion 32. The outer peripheral surface 36 of the first flange portion 35 is connected to the outer peripheral surface 42 of the journal portion 32 by a first side surface 37 extending in the substantially radial direction at an end portion on the other side in the axial direction. In the present embodiment, the first side surface 37 is formed in a direction orthogonal to the central axis m.

A second flange portion 38 protruding in the axial direction toward the journal portion 32 is formed on a side surface of the second crank arm 34b on the one side in the axial direction. The second flange portion 38 has a cylindrical shape coaxial with the journal portion 32, and the outside diameter is equal to that of the first flange portion 35 and larger than the outside diameter of the journal portion 32. The outer peripheral surface 39 of the second flange portion 38 is connected to the outer peripheral surface 42 of the journal portion 32 by a second side surface 40 extending substantially in the radial direction at an end portion on the one side in the axial direction. In the present embodiment, the second side surface 40 is formed in a plane inclined with respect to a plane orthogonal to the central axis m.

The inclination angle θ with respect to a plane orthogonal to the central axis m of the second side surface 40 has a very small value. In FIG. 2, the inclination of the second side surface 40 is exaggerated from the actual inclination in order to clarify the inclined state of the second side surface 40.

When is the point where the second side surface 40 is closest to the second crank arm 34b is the point B1 and the point farthest from the second crank arm 34b is the point B2, the positional shift amount s between the point B1 and the point B2 in the axial direction is preferably set to 1 millimeter or less.

For convenience of the following description, the points on the first side surface 37 facing the point B1 and the point B2 in the axial direction are defined as points A1 and A2, respectively.

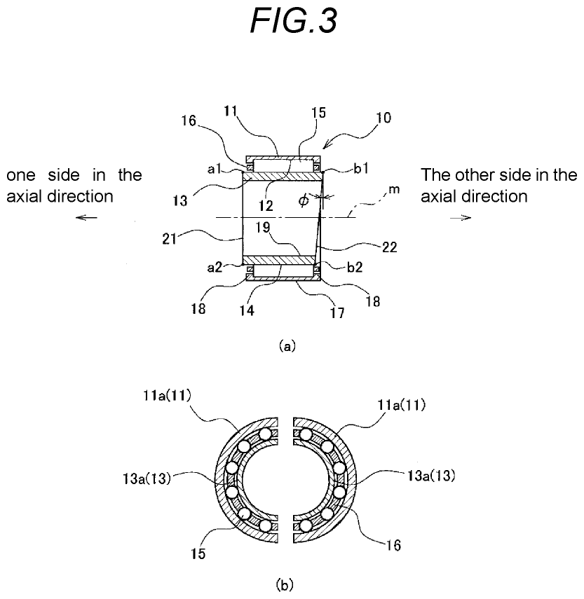

FIG. 3 shows the configuration of the split rolling bearing 10, and FIG. 3(a) is an axial sectional view of the split rolling bearing 10, and FIG. 3(b) is a front view when viewed from the axial direction. In FIG. 3(a), similarly to FIG. 2, the left side of the figure is referred to as the “one side in the axial direction”, and the right side of the figure is described as “the other side in the axial direction”.

The split rolling bearing 10 is a needle roller bearing, and includes an outer ring 11, an inner ring 13, a plurality of needle rollers 15 as rolling elements, and a cage 16. Each of the outer ring 11, the inner ring 13, and the cage 16 is split in two portions into two in the peripheral direction, respectively, and the outer ring 11, the inner ring 13, and the cage 16 are radially separated from each other in FIG. 3(b).

The outer ring 11 is made of high carbon steel such as bearing steel. When two member split in two portions in the peripheral direction (hereinafter, each may be referred to as an “outer ring piece 11a”) are assembled, the members have a substantially cylindrical shape as a whole, and the outer peripheral surface 17 forms a single cylindrical surface. An outer raceway surface 12 on which the needle rollers 15 roll over the entire periphery is formed on the inner periphery. The outer raceway surface 12 has a cylindrical shape coaxial with the outer peripheral surface 17. Flanges 18, 18 having a smaller diameter than the outer raceway surface 12 are formed on the inner periphery of the outer ring 11. The flanges 18, 18 protrude radially inward on both outer sides of the outer raceway surface 12 in the axial direction.

The needle rollers 15 are guided by the flanges 18, 18 to roll in the peripheral direction. The outer peripheral surface 17 and the outer raceway surface 12 are finished by grinding after the outer ring 11 is quenched.

The inner ring 13 is made of high carbon steel such as bearing steel. Two member split in two portions in the peripheral direction (hereinafter, referred to as an “inner ring piece 13a”) have a substantially cylindrical shape as a whole, and the inner peripheral surface 19 forms a single cylindrical surface, and an inner raceway surface 14 in which the needle rollers 15 roll over the entire periphery is formed on the outer periphery at the center in the axial direction. The inner raceway surface 14 has a cylindrical shape coaxial with the inner peripheral surface 19. The inner peripheral surface 19 and the inner raceway surface 14 are finished by grinding after the inner ring 13 is quenched.

The inner ring 13 is provided with a first end surface 21 connecting the inner periphery to the outer periphery in the radial direction at an end portion on one side in the axial direction, and a second end surface 22 connecting the inner periphery and the outer periphery in a substantially radial direction at an end portion on the other side in the axial direction. The first end surface 21 is formed in the same direction as the first side surface 37, and the second end surface 22 is formed in the same direction as the second side surface 40. The same direction means that the directions of the normals of the surfaces are the same as each other. That is, the first end surface 21 is formed in a plane orthogonal to the central axis m. The second end surface 22 is slightly inclined with respect to a plane orthogonal to the central axis m. The inclination angle φ of the second end surface 22 with respect to the plane orthogonal to the central axis m is equal to the inclination angle θ of the second side surface 40 forming the second flange portion 38 of the crankshaft 30.

In FIG. 3(a), the inclination angle φ of the second end surface 22 is exaggerated from the actual inclination in order to clarify the inclined state of the second end surface 22.

The inner ring 13 is mounted on the outer periphery of the journal portion 32 between the first side surface 37 and the second side surface 40. The axial length of the inner ring 13 is set as follows with respect to the axial dimensions of the first side surface 37 and the second side surface 40.

As shown in FIG. 3(a), the points where the first end surface 21 and the second end surface 22 are farthest from each other in the axial direction are a point a1 and the point b1, respectively, and the points where the first end surface 21 and the second end surface 22 are the closest from each other in the axial direction are a point a2 and a point b2, respectively. The dimension between the point a1 and the point b1 is equal to or slightly smaller than the dimension between the point A1 on the first side surface 37 and the point B1 on the second side surface 40, and is larger than the dimension between the point A2 and the point B2. The dimension between the point a2 and the point b2 is equal to or slightly smaller than the dimension between the point A2 and the point B2.

In the present embodiment, the inner ring 13 is split in the peripheral direction by the point b1 or the point b2 and a plane (split plane) including the central axis m. The inner ring 13 is sufficient as long as it is split in two portions by a plane including the central axis m, and the direction of the split plane is not limited to the present embodiment. For example, the split plane may be a split plane that includes a central axis m and is orthogonal to the split plane of the present embodiment.

The needle rollers 15 have a cylindrical shape and are made of a steel material such as bearing steel. In the split rolling bearing 10, the outer ring 11 is coaxially disposed outside the inner ring 13 in the radial direction, and a plurality of needle rollers 15 are disposed between the outer ring 11 and the inner ring 13 with the axes thereof oriented in the same direction as the central axis m.

The cage 16 has a thin cylindrical shape, and is made of a resin material such as polyamide or a thin carbon steel plate. The cage 16 includes a plurality of holes (not shown) penetrating in the radial direction called “pockets”. The pockets are provided at equal intervals in the peripheral direction, and the needle rollers 15 are disposed at equal intervals in the peripheral direction by being accommodated in the respective pockets.

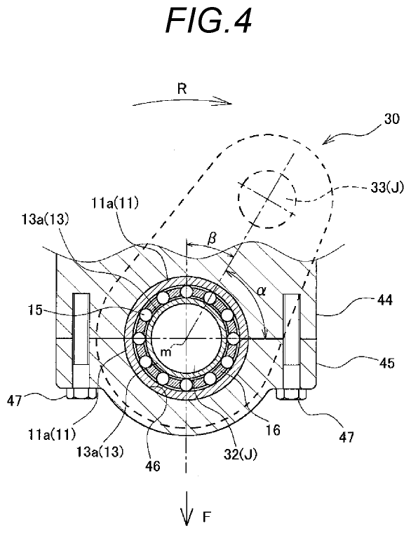

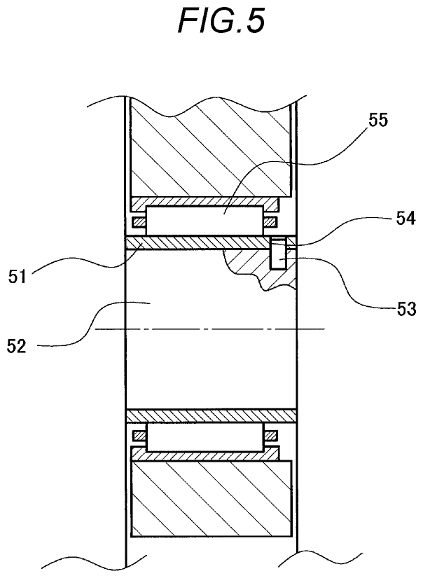

FIG. 4 is a sectional view of the journal portion 32 taken along the line X-X indicated by the arrow J in FIG. 1 in a direction orthogonal to the central axis m. In addition, the positions of the adjacent pin portions 33 (denoted by reference numerals (J) in FIG. 1) are indicated by broken lines. Referring to FIGS. 2 and 3 as appropriate, the mounting state and the working effects of the split rolling bearing 10 will be described according to FIG. 4.

As shown in FIG. 4, the split rolling bearing 10 split into two portions (see FIG. 3(b)) is assembled to the journal portion 32 from both sides in the radial direction.

When the split rolling bearing 10 is mounted, first, the two split inner ring pieces 13a, 13a are attached, and then the outer ring pieces 11a, 11a in which the needle rollers 15 and the cage 16 are incorporated are assembled to the inner periphery.

The inner ring 13 is incorporated such that the first end surface 21 faces the first side surface 37 of the first flange portion 35 in the axial direction and the second end surface 22 faces the second side surface 40 of the second flange portion 38 in the axial direction, and the inclining directions of the second end surface 22 and the second side surface 40 coincide with each other (see FIG. 2). At this time, the inner ring 13 is assembled in a direction in which the point b1 (see FIG. 3) of the second end surface 22 and the point B1 of the second flange portion 38 coincide with each other.

The bore diameter of the inner ring 13 integrally assembled is slightly smaller than the outside diameter of the journal portion 32. Therefore, when the two split inner ring pieces 13a, 13a are assembled, the inner ring pieces 13a, 13a are radially pressurized and assembled. Thus, when the inner ring 13 is mounted on the outer periphery of the journal portion 32, a radial clearance does not occur between the inner ring 13 and the outer peripheral surface 42 of the journal portion 32.

Next, the outer ring pieces 11a are assembled together with the needle rollers 15 and the cage 16, whereby the split rolling bearing 10 is assembled to the journal portion 32. The split rolling bearing 10 is fixed to an engine block (not shown) by being sandwiched in the radial direction by an upper housing 44 formed integrally with the engine block and a lower housing 45 provided on a side of an oil pan (not shown).

Each of the upper housing 44 and the lower housing 45 has a semicircular inner peripheral surface 46, and when assembled as shown in FIG. 4, the inner peripheral surface 46 thereof is a cylindrical surface having a diameter slightly smaller than the outside diameter of the outer ring 11 of the split rolling bearing 10. By fixing the lower housing 45 to the upper housing 44 with bolts 47, 47, the split rolling bearing 10 is fixed inside each of the housings 44, 45.

When the split rolling bearing 10 is assembled as shown in FIG. 4, the diameter formed by the inner contact area of the needle rollers 15 when rolling on the outer ring 12 is slightly smaller than the diameter of the inner raceway surface 14 of the inner ring 13. When the inner ring 13 rotates together with the journal portion 32, the needle rollers 15 revolve about the central axis m while rolling between the outer raceway surface 12 and the inner raceway surface 14. In this way, the crankshaft 30 can rotate about each journal portion 32 as a rotation axis. The central axis m coincides with the central axis of the journal portion 32.

Next, an effect of preventing rotation of the inner ring 13 by the bearing support structure using the split rolling bearing 10 of the present embodiment will be described.

The inner ring 13 is incorporated such that a direction in which the point b1 of the second end surface 22 and the point B1 of the second flange portion 38 coincide, and the inclining directions of the second end surface 22 and the second side surface 40 coincide with each other. The first side surface 37 of the first flange portion 35 and the first end surface 21 of the inner ring 13 are both formed in a direction orthogonal to the central axis m, and are in surface contact with each other.

The largest value of the axial length of the inner ring 13 (the dimension between the point al and the point b1) is larger than the smallest value of the axial length of the region sandwiched in the axial direction between the first flange 35 and the second flange 38 (the dimension between the point A2 and the point B2). When the inner ring 13 attempts to rotate in the peripheral direction, a region having the longest axial length of the inner ring 13 is displaced in a direction in which an inner width between the first side surface 37 of the first flange portion 35 and the second side surface 40 of the second flange portion 38 decreases. Therefore, when the inner ring 13 comes into contact with the first side surface 37 of the first flange portion 35 and the second side surface 40 of the second flange portion 38, the inner ring 13 does not rotate in the peripheral direction thereafter.

As described above, in the present embodiment, the rotation can be prevented by restraining the inner ring 13 in the axial direction. Since the keys and the pins are not used, these do not protrude toward the outer peripheral side of the inner ring 13.

Since the inclination angle θ of the second side surface 40 is extremely small, the positional shift amount s of the second side surface 40 between the point B1 and the point B2 in the axial direction can be reduced. Therefore, since the amount of protrusion of the second flange 38 from the side surface of the second crank arm 34b on the one side in the axial direction is small, the axial length of the inner raceway surface 14 in contact with the outer periphery of the inner ring 13 and the needle rollers 15 is not restricted.

In this way, in the bearing support structure of the present embodiment, it is not necessary to shorten the axial length of the inner raceway surface 14 of the split rolling bearing 10, and thus it is possible to prevent the load capacity of the split rolling bearing 10 from decreasing. Therefore, it is possible to prevent the inner ring 13 from rotating while ensuring a sufficient rolling life.

Further, in the internal combustion engine, when the piston 31 is displaced upward, the fuel is ignited to bias the pin portion 33 downward. Therefore, immediately after the ignition, the largest load is applied to the journal portion 32. That is, as shown in FIG. 4, when the pin portion 33 rotates by a predetermined angle β in the rotational direction of the crankshaft 30 indicated by the arrow R with reference to a position above the journal portion 32, a maximum load is applied in the direction of the arrow F. The angle β is approximately) 30° (20°<β<40°).

At this time, since the split plane of the inner ring 13 is positioned in the horizontal direction, the maximum load from the piston 31 acts on the center of the inner ring piece 13a in the peripheral direction and does not act on the split plane of the inner ring 13. At this time, the position of the split plane of the inner ring 13 incorporated in the journal portion 32 is a position shifted by a predetermined angle a in the rotational direction of the crankshaft 30 with reference to the direction from the journal portion 32 toward the pin portion 33. As shown in FIG. 4, the angle a is an angle formed by the direction from the journal portion 32 toward the pin portion 33 and the split plane of the inner ring 13, and is approximately 60° (50°<α<70°). In this way, in the load area of the rolling bearing, the needle rollers 15 do not pass through the split plane of the inner ring 13, and the occurrence of abnormal noise can be suppressed.

As described above, in the bearing support structure of the present embodiment, even when the split rolling bearing 10 in which the inner ring 13 is split in the peripheral direction is used, it is possible to prevent the occurrence of abnormal noise over a long period of time by setting the position of the split plane of the inner ring 13 such that the needle rollers 15 do not pass through the load area of the rolling bearing in advance since the rotation of the inner ring 13 can be prevented. Further, since the axial length of the inner raceway surface 14 can be ensured, a good rolling life can be ensured.

In the present embodiment, only the second side surface 40 of the first side surface 37 and the second side surface 40 sandwiching the journal portion 32 in the axial direction is inclined with respect to a plane orthogonal to the central axis m, but the present invention is not limited thereto. For example, both the first side surface 37 and the second side surface 40 may be inclined with respect to a plane orthogonal to the central axis m. At this time, the inclination angle θ1 of the first side surface 37 and the inclination angle θ2 of the second side surface 40 may be the same, and the inclination directions may be opposite to each other, or the inclination angle θ1 and the inclination angle θ2 may be different from each other.

In either case, the first end surface 21 and the second end surface 22 of the inner ring 13 are formed in the same direction as the first side surface 37 and the second side surface 40, respectively.

Further, of the first side surface 37 and the second side surface 40, a surface (first side surface 37 in the present embodiment) formed in a direction orthogonal to the central axis m is formed on the first flange portion 35 protruding in the axial direction from the side surface of the first crank arm 34a toward the journal portion 32. However, the present invention is not limited to this configuration, and the first side surface 37 may be directly formed on the side surface of the first crank arm 34a without providing the first flange portion 35. That is, in this configuration, the inner ring 13 is disposed between the first crank arm 34a and the second flange portion 38.

In the present embodiment, although the case where the split rolling bearing 10 is incorporated in all the journal portions 32 of the crankshaft 30 has been described as an example, a normal annular rolling bearing in which the diameter on one side in the axial direction is smaller than that of the journal portion 32 may be incorporated in the leftmost journal portion 32 in FIG. 1.

The embodiments of the present invention have been described above. However, the embodiments described above are merely examples for implementing the present invention. Therefore, the present invention is not limited to the embodiments described above, and can be implemented by appropriately changing the embodiments described above without departing from the scope of the invention.

The present application is based on a Japanese Patent Application (Japanese Patent Application No. 2018-053364) filed on Mar. 20, 2018, the contents of which are incorporated herein by reference.

### REFERENCE SIGNS LIST

10 Split rolling bearing

11 Outer ring

11a Outer ring piece

12 Outer raceway surface

13 Inner ring

13a Inner ring piece

14 Inner raceway surface

15 Needle roller

16 Cage

17 Outer peripheral surface (Bearing)

18 Flange

19 Inner peripheral surface

21 First end surface

22 Second end surface

30 Crankshaft

31 Piston

32 Journal portion

33 Pin portion

34 Crank arm

34a First crank arm

34b Second crank arm

35 First flange portion

36 Outer peripheral surface

37 First side surface

38 Second flange portion

39 Outer peripheral surface

40 Second side surface

42 Outer peripheral surface

44 Upper housing

45 Lower housing

46 Inner peripheral surface (housing)

47 Bolt

1. A bearing support structure in which a split rolling bearing split in two portions in a peripheral direction is mounted on an outer periphery of a rotatable shaft member,
wherein the shaft member includes:
a cylindrical shaft portion, and
a first side surface and a second side surface facing each other in an axial direction with the shaft portion sandwiched therebetween and extending in a substantially radial direction,
wherein at least one of the first side surface and the second side surface is inclined with respect to a plane orthogonal to a central axis of the shaft member,
wherein the split rolling bearing includes:
an inner ring having a substantially cylindrical shape, an inner raceway surface formed on an outer periphery, and a first end surface and a second end surface that extend substantially in the radial direction at both axial ends, and split into two in the peripheral direction,
an outer ring disposed radially outward of the inner ring, having an outer raceway surface formed on the inner periphery, and split into two in a peripheral direction, and
a plurality of rolling elements disposed between the inner raceway surface and the outer raceway surface,
wherein the inner ring is incorporated in an outer periphery of the shaft portion such that the first end surface and the first side surface face each other in the axial direction and the second end surface and the second side surface face each other in the axial direction, and
wherein rotation of the inner ring with respect to the shaft portion is prevented, by forming the first end surface in the same direction as the first side surface, and forming the second end surface in the same direction as the second side surface.

2. The bearing support structure according to claim 1,
wherein the shaft member is a crankshaft of an internal combustion engine including a journal portion serving as a rotation shaft and a pin portion to which a connecting rod is connected, and
wherein when the split rolling bearing is mounted to the journal portion, the position of the split plane of the inner ring is assembled to a position shifted from 50° to 70° in a rotational direction of the crankshaft with reference to a direction from the journal portion toward the pin portion.
